(19) United States
(12) Patent Application Publication
(10) Pub. No.: US 2017/0236215 A1
(43) Pub. Date: Aug. 17, 2017

(54) USER EXPERIENCE USING SOCIAL AND FINANCIAL INFORMATION

(71) Applicant: International Business Machines Corporation, Armonk, NY (US)

(72) Inventors: Jeffrey N. Eisen, Newton, MA (US); Krishna Kummamuru, Bangalore (IN); Tuhin Sharma, Bangalore (IN); Ravi Tejwani, Cambridge, MA (US)

(21) Appl. No.: 15/041,458

(22) Filed: Feb. 11, 2016

(51) Int. Cl. G06Q 40/00; G06N 99/00; G06Q 50/00

(52) U.S. Cl. CPC G06Q 40/12; G06Q 50/01; G06N 99/005

(57) ABSTRACT

At least one financial information for a user is received. A machine learning model is determined. The machine learning model is determined based on the user. A personality of the user is determined based on the machine learning model and the at least one financial information for the user. A recommendation is provided based on the determined personality of the user.

### BACKGROUND

The present invention relates generally to the field of machine learning models, and more particularly to making predictions using machine learning models.

In computing, machine learning is a subfield of computer science that evolved from the study of pattern recognition and computational learning theory in artificial intelligence. Machine learning explores the study and construction of algorithms that can learn from and make prediction of data. Such algorithms operate by building a model from example inputs in order to make data-driven predictions or decisions.

### SUMMARY OF THE INVENTION

Embodiments of the present invention include a method, computer program product, and system for providing a recommendation using social and financial information. In one embodiment, at least one financial information for a user is received. A machine learning model is determined. The machine learning model is determined based on the user. A personality of the user is determined based on the machine learning model and the at least one financial information for the user. A recommendation is provided based on the determined personality of the user.

### BRIEF DESCRIPTION OF THE DRAWINGS

FIG. 1 depicts a functional block diagram of a data processing environment, in accordance with an embodiment of the present invention;

FIG. 2 depicts a flowchart of operational steps of a program for creating a machine learning model using social information and financial information, in accordance with an embodiment of the present invention;

FIG. 3 depicts a flowchart of operational steps of a program for providing a recommendation using social information and financial information, in accordance with an embodiment of the present invention; and

FIG. 4 depicts a block diagram of components of the computer of FIG. 1, in accordance with an embodiment of the present invention.

### DETAILED DESCRIPTION OF THE PREFERRED EMBODIMENTS

Embodiments of the present invention provide a recommendation using social and financial information. Embodiments of the present invention provide for creating a machine learning model or models using financial information and social information of a group of users. Embodiments of the present invention provide for creating a machine learning model associated with all users, a machine learning associated with a group of users, or a machine learning model associated with the type of request being made. Embodiments of the present invention provide for determining financial information of a user. Embodiments of the present invention provide for determining the personality of the user using a machine learning model and the financial information of the user. Embodiments of the invention provide a recommendation to a user based on the determined personality of the user.

Embodiments of the present invention recognize that current solutions do not take into account the financial transaction information of users. Embodiments of the present invention recognize that the social behavior of a user and their financial transaction profile are not currently mapped.

The present invention will now be described in detail with reference to the Figures.

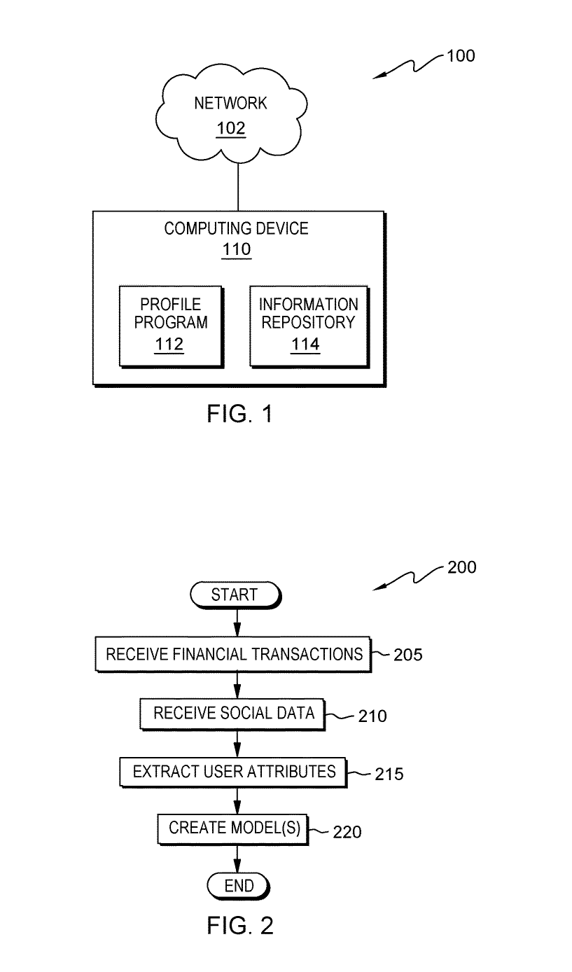

FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

An embodiment of data processing environment 100 includes computing device interconnected over network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between computing device 110 and any other computer connected to network 102, in accordance with embodiments of the present invention.

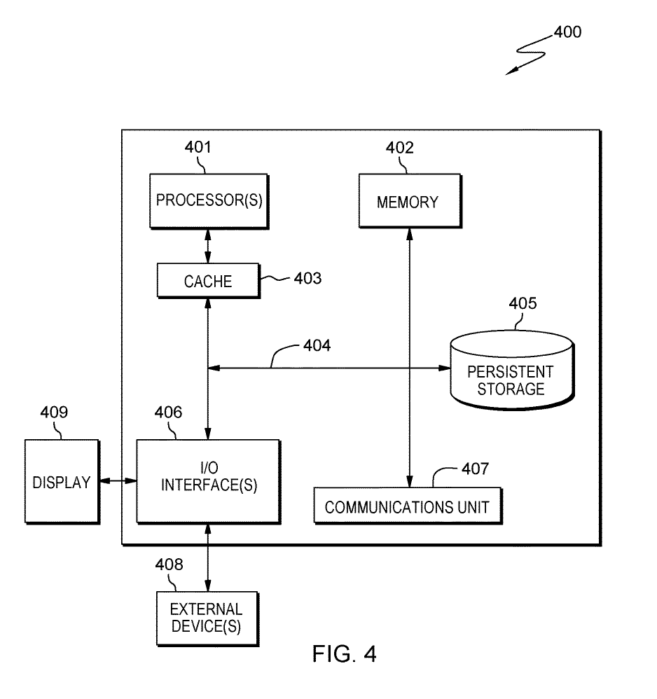

In an embodiment, computing device 110 may be a laptop, tablet, or netbook personal computer (PC), a desktop computer, a personal digital assistant (PDA), a smart phone, camera, video camera, video device or any programmable electronic device capable of communicating with any computing device within data processing environment 100. In certain embodiments, computing device 110 collectively represents a computer system utilizing clustered computers and components (e.g., database server computers, application server computers, etc.) that act as a single pool of seamless resources when accessed by elements of data processing environment 100, such as in a cloud computing environment, discussed previously. In general, computing device 110 is representative of any electronic device or combination of electronic devices capable of executing computer readable program instructions. In an embodiment, computing device 110 may include components as depicted and described in detail with respect to FIG. 4, in accordance with embodiments of the present invention.

In an embodiment, computing device 110 includes profile program 112 and information repository 114. In an embodiment, profile program 112 is a program, application, or subprogram of a larger program for providing a recommendation using social and financial information. In an alternative embodiment, profile program 112 may be located on any other device accessible by computing device 110 via network 102. In an embodiment, information repository 114 may include a single machine learning model or multiple machine learning models and each of the machine learning models is associated with a group of users. In an embodiment, the machine learning model is a model of the relationship between the financial information of a group of users and the social data of the group of users. In an embodiment, profile program 112 extracts personality traits (e.g., openness, conscientiousness, extraversion, agreeableness, and neuroticism) from the social data of the group of users and the financial information of the group of users is mapped to the extracted personality traits. In an alternative embodiment, information repository 114 may be located on any other device accessible by computing device 110 via network 102.

In an embodiment, profile program 112 may determine a user that needs a recommendation using social and financial information. In an embodiment, the recommendation may be related to a financial inquiry or request of the user. In an embodiment, profile program 112 may receive financial information associated with the user. In an embodiment, profile program 112 may retrieve the financial information associated with the user from information repository 114. In an alternative embodiment, profile program 112 may request financial information from a financial institution (i.e., bank, hedge fund, financial planner, etc.) and store the received financial information associate with the user in information repository 114. In an embodiment, profile program 112 determines the machine learning model to use for the financial inquiry or request of the user. In an embodiment, profile program 112 may determine a single machine learning model to use that is associated with all users. In an alternative embodiment, profile program 112 may determine a machine learning model that is associated with a group of users that is similar to the user that makes the financial inquiry or request. In yet another alternative embodiment, profile program 112 may determine a machine learning model that is associated with the type of inquiry or request the user has made. In an embodiment, profile program 112 determines the personality of the user using the social information associated with the user, the financial information associated with the user, and the determined machine learning model. In an embodiment, profile program 112 provides a recommendation based on the determined personality of the user and the financial inquiry or request of the user. In an alternative embodiment, profile program 112 may provide a recommendation based on the determined personality of the user without need of a financial inquiry or request from the user.

A machine learning model includes the construction and implementation of algorithms that can learn from and make predictions on data. The algorithms operate by building a model from example inputs in order to make data-driven predictions or decisions, rather than following strictly static program instructions. In an embodiment, the model is a system which explains the behavior of some system, generally at the level where some alteration of the model predicts some alteration of the real-world system. In an embodiment, a machine learning model may be used in a case where the data becomes available in a sequential fashion, in order to determine a mapping from the dataset to corresponding labels. In an embodiment, the goal of the machine learning model is to minimize some performance criteria using a loss function. In an embodiment, the goal of the machine learning model is to minimize the number of mistakes when dealing with classification problems. In yet another embodiment, the machine learning model may be any other model known in the art. In an embodiment, the machine learning model may be a SVM “Support Vector Machine”. In an alternative embodiment, the machine learning model may be any supervised learning regression algorithm. In yet another embodiment, the machine learning model may be a neural network.

In an embodiment, there may be one machine learning model created using all the information supplied about all users. In an embodiment, the information about the users may be supplied initially and a machine learning model is created. In an embodiment, the information may be updated and the associated machine learning model is updated accordingly using the updated information. In an alternative embodiment, there may be more than one machine learning model and each machine learning model may be associated with a group of users. For example, there may be a machine learning model for users between the ages of 15-20, a machine learning model for users between the ages of 21-25, a machine learning model for users between the ages of 26-30, etc. In an embodiment, the financial information or vectors used to build the machine learning model(s) may include one or more of the following: minimum balance of one or more financial accounts, maximum balance of one or more financial accounts, maximum amount of money spent in a transaction, salary of user, type of merchant the money is spent, time the money is spent, location the money is spent, average/maximum/minimum amount of money spent at different categories or types of merchants, categories of locations of the merchant (i.e., urban, rural, city, etc.), type of investments, etc. In an embodiment, the information or vectors used to build the machine learning model(s) may also include any social information, including, but not limited to: age, gender, marital status, education, information found in data interactions (i.e., email, text messages on phone devices, chat transcripts on a computing devices, etc.) or any other information that can be taken from social networking platforms. In an embodiment, the output of the machine learning model is the personality of the user. In an embodiment, the personality of the user may include, but is not limited to, the openness, conscientiousness, extraversion, agreeableness, and neuroticism of the user.

In an embodiment, profile program 112 may include a user interface that allows a user to interact with profile program 112. A user interface (not shown) is a program that provides an interface between a user and profile program 112. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes information repository 114. In an embodiment, information repository 114 may be managed by profile program 112. In an alternative embodiment, information repository 114 may be managed by the operating system of the computer, alone, or together with, profile program 112. In an embodiment, information repository 114 may include a machine learning model associated with all users. In another embodiment, information repository 114 may include a machine learning model associated with a group of users. In an embodiment, information repository 114 may include social information about at least one user. For example, information repository 114 may include a social profile for User A from Website A. In another example, information repository 114 may include a social profile for User B from Website A and Website B. The social profile may include information including, but not limited to: age, gender, marital status, education, posts on the website, information about products or events the user likes or dislikes, etc. In an embodiment, information repository 114 may include financial information about at least one user. For example, information repository 114 may include information about Transaction A where User A purchased Product A from Company A for Price A.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

FIG. 2 is a flowchart of workflow 200 depicting operational steps for creating a machine learning model using social information and financial information, in accordance with an embodiment of the present invention. In one embodiment, the steps of the workflow are performed by profile program 112. In an alternative embodiment, steps of the workflow can be performed by any other program while working with profile program 112. In a preferred embodiment, a user, via a user interface discussed previously, can invoke workflow 200 upon a user wanting profile program 112 to create a machine learning model for data. In an embodiment, the machine learning model is created for a group of users. In an embodiment, the group of users may be any indicated group of users made by the user invoking the workflow.

Profile program 112 receives financial transactions (step 205). In other words, profile program 112 receives financial transactions of a plurality of users. In an embodiment, profile program 112 may determine financial information associated with the plurality of users that is found in information repository 114. In an alternative embodiment, profile program 112 may request financial information associated with the plurality of users from another program (i.e., a banking application, a stock market application, etc.) and the program may be found on computing device 110 or found on another device accessible to computing device 110 via network 102. Upon receiving the requested financial information, profile program 112 stores the financial information for the users in information repository 114. In an embodiment, the financial information may include one or more of the following: minimum balance of one or more financial accounts, maximum balance of one or more financial accounts, maximum amount of money spent in a transaction, salary of user, type of merchant the money is spent, time the money is spent, location the money is spent, average/maximum/minimum amount of money spent at different categories or types of merchants, categories of locations of the merchant (i.e., urban, rural, city, etc.), type of investments, etc.

Profile program 112 receives social data (step 210). In other words, profile program 112 receives social data of some or all of the plurality of users in the previous step. In an embodiment, profile program 112 may determine social data associated with the plurality of users that is found in information repository 114. In an alternative embodiment, profile program 112 may request social data associated with the plurality of users from another program (i.e., a social messaging application, a stock posting application, emails, chat/messaging transcripts, etc.) and the program may be found on computing device 110 or found on another device accessible to computing device 110 via network 102. Upon receiving the requested social data, profile program 112 stores the social data for the users in information repository 114. In an embodiment, the social data may include any social information, including, but not limited to: age, gender, marital status, education, information found in data interactions (i.e., email, text messages on phone devices, chat transcripts on a computing devices, etc.) or any other information that can be taken from social networking platforms. In an embodiment, profile program 112 may extract specific characteristics (i.e., openness, conscientiousness, extraversion, agreeableness, neuroticism, etc.) from the social data so the characteristics will fit more accurately in the machine learning model that is created.

Profile program 112 extracts user attributes (step 215). In other words, profile program 112 determines user attributes from the financial transactions of the plurality of users received previously and the social data of the plurality of users received previously. In an embodiment, profile program 112 may extract specific financial features from the financial information so the financial features will fit more accurately in the machine learning model that is created. In an embodiment, profile program 112 may extract specific characteristics (e.g., openness, conscientiousness, extraversion, agreeableness, neuroticism, etc.) from the social data so the characteristics will fit more accurately in the machine learning model that is created. In an embodiment, profile program 112 may extract any user attributes from financial transactions or social data that may be used as vectors to create the machine learning model.

Profile program 112 creates model(s) (step 220). In other words, profile program 112 creates a single machine learning model or multiple machine learning models using the extracted attributes determined previously. In an embodiment, there may be one machine learning model created using all the extracted attributes determined previously. In an alternative embodiment, there may be more than one machine learning model and each machine learning model may be associated with a group of users. For example, there may be a machine learning model for users between the ages of 15-20, a machine learning model for users between the ages of 21-25, a machine learning model for users between the ages of 26-30, etc. In an embodiment, profile program 112 may receive an indication from a user and the indication may include the groups the users may be broken in to determine the plurality of machine learning model. In an alternative embodiment, profile program 112 may determine different trends found in groups of users to determine the optimal machine learning models. For example, profile program 112 may determine that spending/saving habits of users change significantly around the age of 25 and therefore there is a machine learning model created for users under the age of 25 and for users over the age of 25. In an embodiment, the financial transactions received in step 205 and the social data received in step 210 may be used to modify, update, or edit machine learning models created previously.

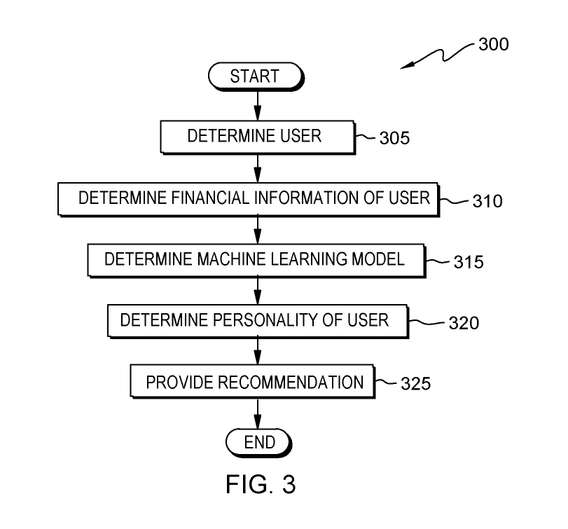

FIG. 3 is a flowchart of workflow 300 depicting operational steps for a user that needs a recommendation using social information and financial information, in accordance with an embodiment of the present invention. In one embodiment, the steps of the workflow are performed by profile program 112. In an alternative embodiment, steps of the workflow can be performed by any other program while working with profile program 112. In a preferred embodiment, a user, via a user interface discussed previously, can invoke workflow 200 upon a user making a financial inquiry or request to profile program 112.

Profile program 112 determines a user (step 305). In an embodiment, profile program 112 may receive an indication from a user, via a user interface, regarding a user or users that profile program 112 will be providing a recommendation for. In an embodiment, the user making the indication may be the same user that the profile program 112 will be making the recommendation for. For example, User A may indicate to profile program 112 that User A would like a recommendation for User A. In another embodiment, the user may make indication that profile program 112 will be making a recommendation for another user. For example, User A may indicate to profile program 112 that User A would like a recommendation for User B. In an embodiment, profile program 112 may also receive a request associated with the user that profile program 112 is to make a recommendation for. For example, profile program 112 receives an indication of providing a recommendation for User A and User A also has a request, “How much can I be preapproved for a mortgage?”

Profile program 112 determines financial information for the user (step 310). In other words, profile program 112 determines financial information related to the user that is determined in the previous step. In an embodiment, profile program 112 may determine financial information associated with the user that is found in information repository 114. In an alternative embodiment, profile program 112 may request financial information associated with the user from another program and the program may be found on computing device 110 or found on another device accessible to computing device 110 via network 102. In an embodiment, financial information may include, but is not limited to: minimum balance of one or more financial accounts, maximum balance of one or more financial accounts, maximum amount of money spent in a transaction, salary of user, type of merchant the money is spent, time the money is spent, location the money is spent, average/maximum/minimum amount of money spent at different categories or types of merchants, categories of locations of the merchant (i.e., urban, rural, city, etc.), type of investments, etc. For example, profile program 112 may request financial information about User A from Bank A and profile program 112 may determine the financial information for User A includes: Bank Account 1 with a minimum balance of $100 and a maximum balance of $789, User A spends 30% of their money in urban environment, User A spends 40% of their money in rural environments, and User A spends 30% in other environments, and that User A spends 50% of their money on essential items (i.e., rent, food, clothing, mortgage, etc.) and 50% of their money on non-essential items (i.e. vacations, video games, etc.).

Profile program 112 determines a machine learning model (step 315). In other words, profile program 112 determines a machine learning model used to determine the personality of the user. In an embodiment, profile program 112 may determine the machine learning model for the machine learning model(s) found in information repository 114. In an embodiment, information repository 114 may have a single machine learning model and profile program 112 determines that single machine learning model should be used. In an alternative embodiment, information repository 114 may have multiple machine learning models and profile program 112 determines which machine learning model to use. In an embodiment, profile program 112 may make this determination based on age, personality, etc. For example, information repository 114 may include a machine learning model for users between the ages of 15-20, a machine learning model for users between the ages of 21-25, a machine learning model for users between the ages of 26-30, etc. Here, User A is 22 years old, therefore profile program 112 determines that the machine learning model for users between the ages of 21-25 is the machine learning model to use.

Profile program 112 determines the personality of the user (step 320). In other words, profile program 112 determines the personality of the user determined previously using the financial information of the determined user and the machine learning model determined. In an embodiment, the determined personality of the user can include determining the “Big Five”, including, but not limited to, the openness, conscientiousness, extraversion, agreeableness, and neuroticism. In an embodiment, profile program 112 may determine if the user has any, some or all of these traits. In another embodiment, profile program 112 may determine if the personality of the user includes a percentage of these traits. For example, User A has an openness of 78%, conscientiousness of 36%, extraversion of 64%, agreeableness of 58%, and a neuroticism of 22%. In another embodiment, profile program 112 can determine one or more personality traits that are associated with the request of the user. In the previous example, the user requested, “How much can I be preapproved for a mortgage?” and profile program 112 may determine the credit risk profile of the user so as to be able to determine a monetary value to preapprove the user for.

Profile program 112 provides a recommendation (step 325). In other words, profile program 112 determines a recommendation to provide to the user based on the determined personality. For example, if it is determined that User A has an openness of 78%, conscientiousness of 36%, extraversion of 64%, agreeableness of 58%, and a neuroticism of 22% then profile program 112 may provide a recommendation that the user be offered a credit card at a lower interest rate than a person with other personalities. In another example, if the credit risk of the user was determined to be minimal then profile program 112 may determine that the user that requested, “How much can I be preapproved for a mortgage?” should be offered a preapproval for a certain amount of money or a range of amount of money (i.e. $100,000 or $80,000-$110,000).

FIG. 4 depicts computer system 400, which is an example of a system that includes profile program 112. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for providing a recommendation using social and financial information, the method comprising the steps of:
receiving, by one or more computer processors, at least one financial information for a user;
determining, by one or more computer processors, a machine learning model, wherein the machine learning model is determined based on the user;
determining, by one or more computer processors, a personality of the user based on the machine learning model and the at least one financial information for the user; and
providing, by one or more computer processors, a recommendation based on the determined personality of the user.

2. The method of claim 1, wherein the step of determining, by one or more computer processors, a machine learning model, wherein the machine learning model is determined based on the user, comprise:
determining, by one or more computer processors, one or more financial transactions of a plurality of users;
determining, by one or more computer processors, one or more social data of the plurality of users;
determining, by one or more computer processors, at least one user attributes for each user of the plurality of users from the one or more financial transactions of the user and the one or more social data of the user; and
creating, by one or more computer processors, at least one machine learning model from the at least one user attributes for the plurality of users.

3. The method of claim 1, wherein the financial information is one or more of the following: a minimum balance of one or more financial accounts of the user, a maximum balance of one or more financial accounts of the user, a maximum amount of money spent in a transaction by the user, and a salary of user.

4. The method of claim 2, wherein the social data is one or more of the following: age, gender, marital status, education, and at least one set of information found in at least one data interaction.

5. The method of claim 1, wherein the personality includes one or more of the following traits: openness, conscientiousness, extraversion, agreeableness, and neuroticism.

6. The method of claim 1, wherein the recommendation is in response to a request received about the user.

7. The method of claim 3, wherein the financial information further includes one or more of the following: a type of merchant money is spent by the user, a time money is spent by the user, a location money is spent by a user, an average amount of money spent at different categories of merchants by the user, a maximum amount of money spent at different categories of merchants by the user, a minimum amount of money spent at different categories of merchants by the user, at least one category of locations of the merchant, and type of investments of the user.

8. A computer program product for providing a recommendation using social and financial information, the computer program product comprising:
one or more computer readable storage media; and
program instructions stored on the one or more computer readable storage media, the program instructions comprising:
program instructions to receive at least one financial information for a user;
program instructions to determine a machine learning model, wherein the machine learning model is determined based on the user;
program instructions to determine a personality of a user base on the machine learning model and the at least one financial information for the user; and
program instructions to provide a recommendation based on the determined personality of the user.

9. The computer program product of claim 8, wherein the program instructions to determine the machine learning model, wherein the machine learning model is determined based on the user, comprise:
program instructions to determine one or more financial transactions of a plurality of users;
program instructions to determine one or more social date of the plurality of users;
program instructions to determine at least one user attributes for each user of the plurality of users from the one or more financial transactions of the user and the one or more social data of the user; and
program instructions to create at least one machine leaning model from the at least one user attributes for the plurality of users.

10. The computer program product of claim 8, wherein the financial information is one or more of the following: a minimum balance of one or more financial accounts of the user, a maximum balance of one or more financial accounts of the user, a maximum amount of money spent in a transaction by the user, and a salary of user.

11. The computer program product of claim 9, wherein the social data is one or more of the following: age, gender, marital status, education, and at least one set of information found in at least one data interaction.

12. The computer program product of claim 8, wherein the personality includes one or more of the following traits: openness, conscientiousness, extraversion, agreeableness, and neuroticism.

13. The computer program product of claim 8, wherein the recommendation is in response to a request received about the user.

14. The computer program product of claim 10, wherein the financial information further includes one or more of the following: a type of merchant money is spent by the user, a time money is spent by the user, a location money is spent by a user, an average amount of money spent at different categories of merchants by the user, a maximum amount of money spent at different categories of merchants by the user, a minimum amount of money spent at different categories of merchants by the user, at least one category of locations of the merchant, and type of investments of the user.

15. A computer system for providing a recommendation using social and financial information, the computer system comprising:
one or more computer processors;
one or more computer readable storage media; and
program instructions stored on the one or more computer readable storage media for execution by at least one of the one or more computer processors, the program instructions comprising:
program instructions to receive at least one financial information for a user;
program instructions to determine a machine learning model, wherein the machine learning model is determined based on the user;
program instructions to determine a personality of a user base on the machine learning model and the at least one financial information for the user; and
program instructions to provide a recommendation based on the determined personality of the user.

16. The computer system of claim 15, wherein the program instructions to determine the machine learning model, wherein the machine learning model is determined based on the user, comprise:
program instructions to determine one or more financial transactions of a plurality of users;
program instructions to determine one or more social date of the plurality of users;
program instructions to determine at least one user attributes for each user of the plurality of users from the one or more financial transactions of the user and the one or more social data of the user; and
program instructions to create at least one machine leaning model from the at least one user attributes for the plurality of users.

17. The computer system of claim 15, wherein the financial information is one or more of the following: a minimum balance of one or more financial accounts of the user, a maximum balance of one or more financial accounts of the user, a maximum amount of money spent in a transaction by the user, a salary of user, a type of merchant money is spent by the user, a time money is spent by the user, a location money is spent by a user, an average amount of money spent at different categories of merchants by the user, a maximum amount of money spent at different categories of merchants by the user, a minimum amount of money spent at different categories of merchants by the user, at least one category of locations of the merchant, and type of investments of the user.

18. The computer system of claim 16, wherein the social data is one or more of the following: age, gender, marital status, education, and at least one set of information found in at least one data interaction.

19. The computer system of claim 15, wherein the personality includes one or more of the following traits: openness, conscientiousness, extraversion, agreeableness, and neuroticism.

20. The computer system of claim 15, wherein the recommendation is in response to a request received about the user.
